(19) United States
(12) Patent Application Publication
(10) Pub. No.: US 2010/0086387 A1
(43) Pub. Date: Apr. 8, 2010

(54) Trash receptacle loading frame

(76) Inventors: Scott C. Fought, Orangeville, PA (US); Ann M. Fought, Orangeville, PA (US)

Correspondence Address: LITMAN LAW OFFICES, LTD., POST OFFICE BOX 41200, SOUTH STATION, ARLINGTON, VA, 22204, US

(21) Appl. No.: 12/285,365

(22) Filed: Oct. 2, 2008

(51) Int. Cl. B65F 3/00

(52) U.S. Cl. 414/491

(57) ABSTRACT

The trash receptacle loading frame is a trash container cradle engageable with a front load or rear load hook truck for loading and transport on the truck. The trash receptacle loading frame allows one truck to do many different duties, maximizing potential and efficiency of the operator. The inventive cradle features a substantially open rectangular steel frame provided at a front end with an upstanding truck hook engaging component and at a rear end with hooks for engagement with the grab bars of both front and rear load containers. The rear latching hooks may include two safety latches at the top to lock in the top bar of the container, on rear load models, as well as two bars that will lock in place to keep the container from shifting left or right during transport, thus securing the container to the attachment.

### BACKGROUND OF THE INVENTION

1. Field of the Invention

The present invention relates generally to hauling assemblies, and more specifically, to a trash receptacle loading frame that provides a cradle or frame designed to receive trash containers for loading onto a truck.

2. Description of the Related Art

The trash industry mainly uses four major types of trucks, the types being a rear loader, a front loader, a roll-off, and a hook truck. The rear load truck usually is associated with two personnel on the back and seen primarily in residential areas, however it does have the ability to handle dumpsters, commonly referred to as rear load dumpsters. The front loader is primarily a container dumping truck, usually seen in strip malls or places of retail services and the food industry. The roll-off truck is generally used in the demolition and construction industry as well as factory and larger scale jobs. The fourth type, a hook truck, has many applications. Other truck types in use for hauling include flat beds, small septic tankers, storage trailers and the like. It would be desirable to have an attachment that would go on the hook truck, be loaded onto the truck like all other applications, and used solely to move rear and front load containers from place to place, with ease and far less cost than is currently possible.

Currently for rear load haulers to move their containers, (which range in size from 2-10 cubic yard, yet have the same measurement in width and height, the only variation being the length) they must use the same big, bulky, truck to move the can from a yard to a job, or from house to house for clean up and so on. Rear load hauling trucks usually get 3-5 miles per gallon, and are generally a tandem or tri-axle truck, which can be very difficult to maneuver through the inner cities as well as rural America.

The front load hauling trucks are specifically designed for delivery of front-loading containers. A front load hauling truck alone can be a fifty to eighty thousand dollar investment just for the purpose of moving containers. Due to the laws that restrict placement of the container on the front of a trash truck, the front load hauling truck is a must. This type of truck also gets about 10 miles to the gallon, however is a large investment with only one purpose, to move cans. Once a can is in place the front load truck operator may not go back to move the can for years. Although these cans range in size from 2-12 cubic yards, the lifting point on all front load containers is located in the same location for all cans.

Although there are many manufactures of all styles of containers, each share a few common points. For the rear load containers, all front bars are the same height and length which becomes their rotating point during lifting as well as the point in which they are safely hooked on the truck for dumping. For the front load style cans, they all share in these common hooking/lifting points. We find that even though there are many styles and brands of trucks they all share these features to allow the hauler to choose from a number of manufactures, making it easier to buy from different manufactures and have confidence your current inventory will work with new additions to your fleet or assets.

Most haulers today, have not only a packer type truck, be it a rear load or a front load, but they also have either the hook version or the roll-off type of container truck, and most have a combination of 3 or all 4, it just seems to be the norm for the industry. To save the buyer money and time, it would be preferable to move around in a truck that gets between 10-15 mpg, rather 3-5 mpg, then expenses due to fuel and vehicle wear and tear on the much larger more costly trucks could be avoided.

Thus, a trash receptacle loading frame solving the aforementioned problems is desired.

### SUMMARY OF THE INVENTION

The trash receptacle loading frame is a trash container cradle engageable with a front load or rear load hook truck for loading and transport on the truck. The inventive trash receptacle loading frame allows one truck to do many different duties, maximizing potential and efficiency of the operator. The inventive cradle features a substantially open rectangular steel frame provided at a front end with an upstanding truck hook engaging component and, at a rear end, an open container support frame with hooks that engage the grab bars of both front and rear load containers. The rear latching hooks may include two safety latches at the top to lock in the top bar of the container, on rear load models, as well as two bars that will lock in place to keep the container from shifting left or right during transport, thus securing the container to the attachment.

These and other features of the present invention will become readily apparent upon further review of the following specification and drawings.

### BRIEF DESCRIPTION OF THE DRAWINGS

FIG. 1 is an environmental, perspective view of a trash receptacle loading frame according to the present invention.

FIG. 2 is an environmental, perspective view of the trash receptacle hauler in a mid-loading configuration, according to the present invention.

FIG. 3 is an environmental, perspective view of the trash receptacle hauler in a fully-loaded configuration on a truck, according to the present invention.

FIG. 4 is a perspective view of the trash receptacle hauler, according to the present invention.

Similar reference characters denote corresponding features consistently throughout the attached drawings.

### DETAILED DESCRIPTION OF THE PREFERRED EMBODIMENT

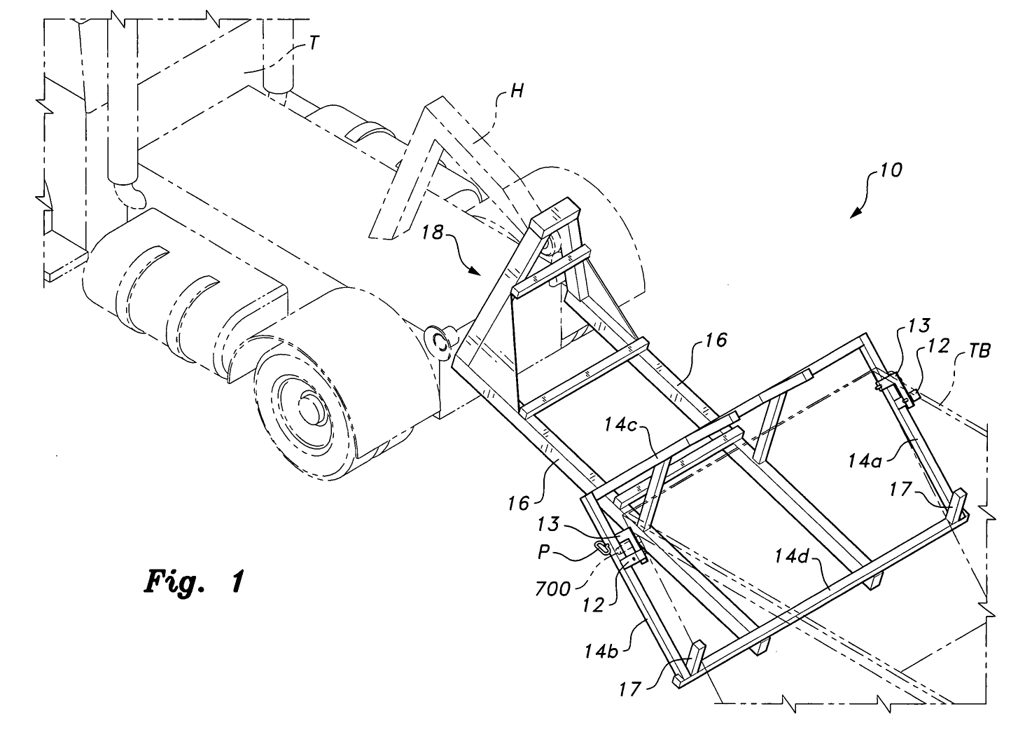

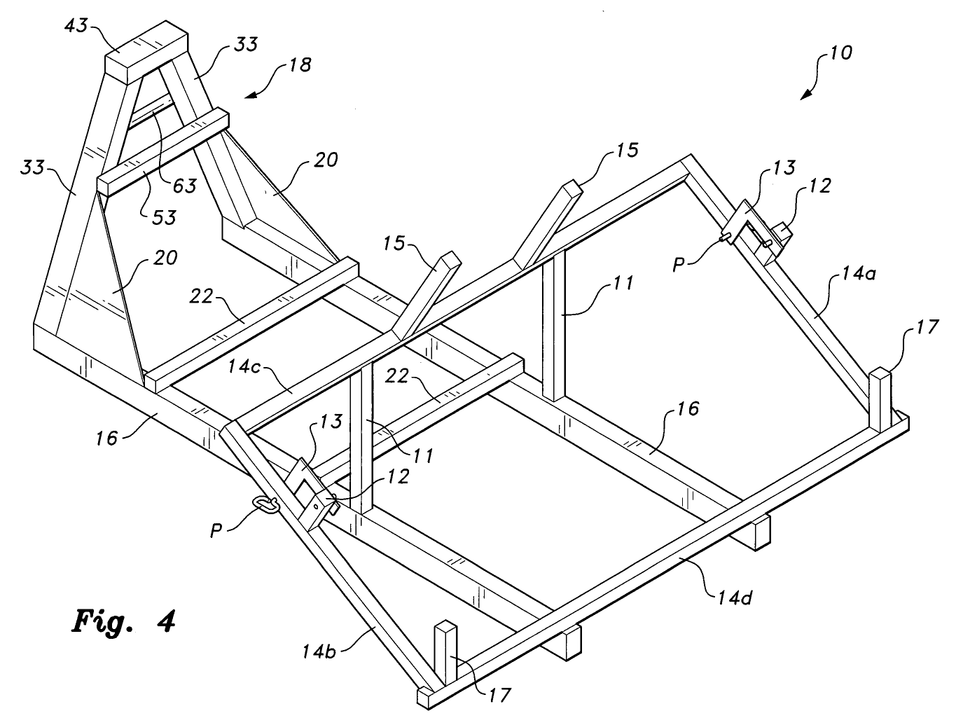

As shown in FIGS. 1-4, the present invention is a trash container loading frame 10 engageable with a hooking member H of a front load or rear load hook truck T for loading and transport of a trash bin TB on the truck T. The inventive trash receptacle loading frame allows one truck to do many different duties, maximizing potential and efficiency of the operator.

The bottom of trash receptacle loading frame 10 is comprised of elongate longitudinal roll off members 16, which are sturdily designed to engage, and roll-on or off a frame of a hook truck T.

Elongate longitudinal roll off members 16 form a substantially open rectangular steel frame 10 that includes at its front end an A frame shaped upstanding truck hook engaging member 18, and, at its rear end, trash bin engagement hooks 12, the trash bin engagement hooks 12 being engageable to hook grab bars of both front and rear load trash containers. At least one lateral cross member 22 interconnects the elongate longitudinal roll off members 16 to keep them laterally constrained in a rigid manner.

The A frame shaped truck hook engaging member 18 is a member that extends upward from the front end of longitudinal roll off members 16. Two hook member braces, solid trusses 20, are connected between the truck hook engaging member 18 and lower frame members 16. A laterally extending brace 53 connects the two upward extending legs 33 of hook engaging member 18. Hook bar 63 extends laterally between and attached to the opposing upward extending legs 33. The hook bar 63 facilitates engagement of a truck hook H with the hook engaging member 18. Laterally extending top portion 43 of the A frame member 18 interconnects the two extending legs 33 at their top.

A trash bin support frame is a substantially parallelepiped member. A front portion is connected to the roll-off members 16 via standoff members 11, the standoff members 11 raising up the front portion of the trash bin support frame away from the roll-off members 16 at an angle. A rear portion of the parallelepiped trash bin support frame is rigidly attached to the rear portion of roll off members 16 via trash bin support lateral member 14d.

The trash bin engagement hooks 12 can be formed from bosses that extend from the substantially parallelepiped trash bin support frame at the rear portion of the frame 10.

The parallelepiped trash bin support frame is comprised of a pair of trash bin support longitudinal members 14a, 14b, attached to a pair of trash bin support lateral members, 14c, 14d. The trash bin engagement hook bosses extend from upper portion of respective trash bin support longitudinal members 14a and 14b. Safety latches 13 are pivotally attached to a respective engagement hook 12. The safety latches 13 are perpendicularly shaped members that have a latching bore at their ends. Longitudinal frame members 14a, 14b each have corresponding bores that the latching bores of pivoting latch members 13 can be aligned with. Each safety latch 13 is secured to frame member 14b via a pin P that can be inserted in aligned through bores in frame member 14b and latch 13 to lock in a grab bar 700 of a trash bin TB.

Additionally, lateral constraining bosses 17 extend from opposing sides of trash bin support lateral member 14d. The lateral constraining bosses 17 constrain side-to-side movement of a trash bin cradled by the parallelepiped frame assembly.

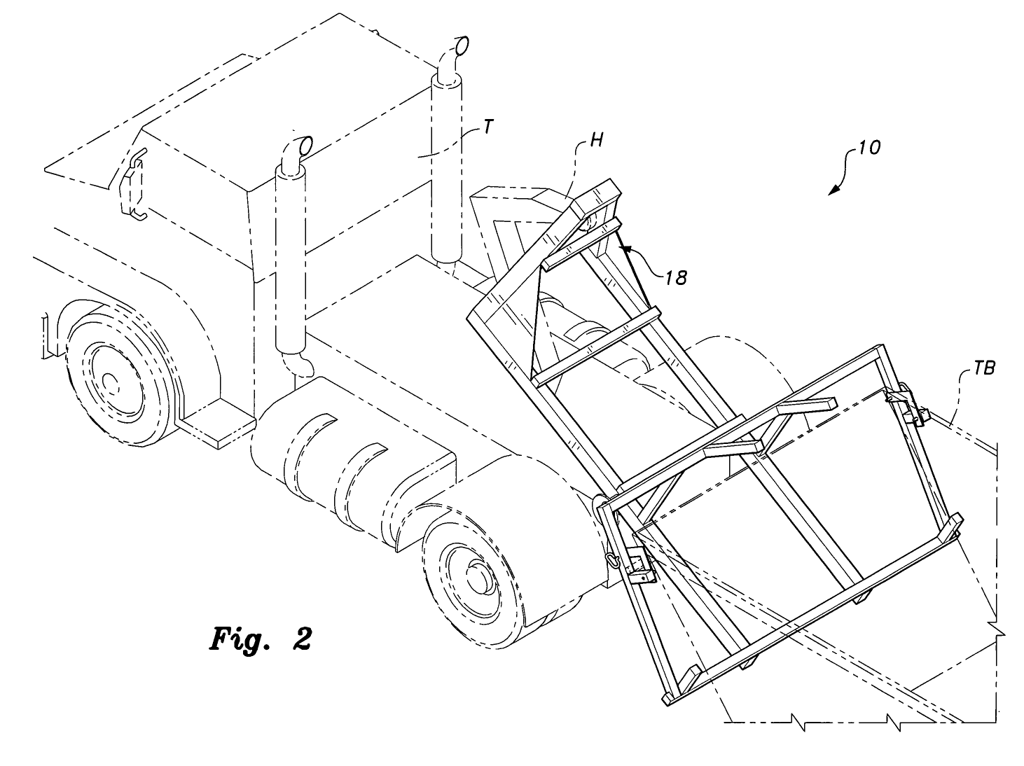

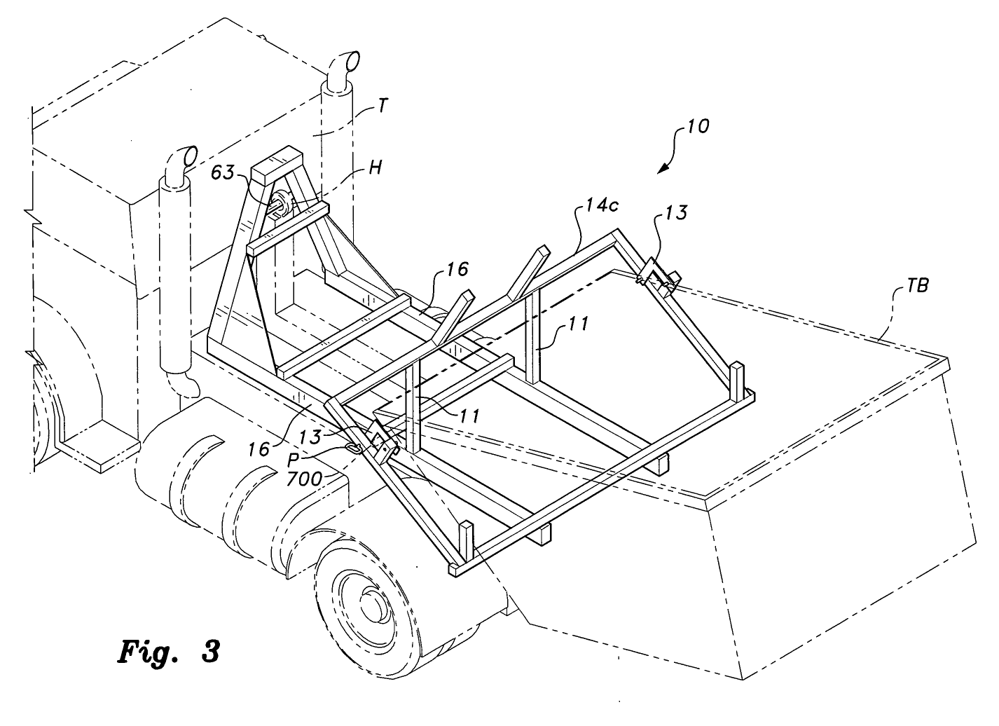

As shown in FIG. 1, the trash receptacle loading frame 10 is engaged with the hook of hook truck T and, by means of the truck's hook, disposed in a trash bin loading position in contact with both the ground and the truck T. The trash bin is rolled adjacent to the frame, the grab bar of the trash bin being hooked to the trash bin engagement hooks 12. The truck hook then slides trash receptacle loading frame 10 with attached trash bin back onto the truck T, as shown in FIGS. 2 and 3. Any excessive pivoting motion of trash bin TB during loading and/or hauling of the trash bin TB is constrained by anti tip members 15 that extend from a middle portion of trash bin support lateral member 14c.

It is to be understood that the present invention is not limited to the embodiment described above, but encompasses any and all embodiments within the scope of the following claims.

We claim:

1. A trash receptacle loading frame, comprising:
a substantially open rectangular frame having a pair of longitudinally extending roll-off members forming a bottom portion of the loading frame;
an A-frame member extending upward from a front end of the roll off members;
a substantially parallelepiped frame disposed at the rear end of the roll off members, the substantially parallelepiped frame having a front portion raised up at an angle from the roll-off members; and
latching trash bin engagement hooks extending upward from the front portion of the substantially parallelepiped frame;
wherein a hook truck appendage engages the A frame shaped member to position a portion of the loading frame on the ground, a trash bin engages the trash bin engagement hooks, the trash bin resting on the substantially parallelepiped frame, the hook truck appendage pulling the loading frame onto the truck to secure the trash bin for hauling by the truck.

2. The trash receptacle loading frame according to claim 1, further comprising at least one laterally extending brace attached between the roll-off members to keep the roll off members laterally rigid.

3. The trash receptacle loading frame according to claim 1, further comprising at least one A-frame member brace, the A-frame member brace constraining pivotal movement of the A-frame member.

4. The trash receptacle loading frame according to claim 1, wherein a mechanism of the latching trash bin engagement hooks pivotally engages the parallelepiped frame thereby securing the trash bin to the parallelepiped frame.

5. The trash receptacle loading frame according to claim 1, further comprising laterally opposing bosses extending from the parallelepiped frame, the laterally opposing bosses laterally constraining the trash bin to the parallelepiped frame.

6. The trash receptacle loading frame according to claim 1, further comprising elongate anti-tip members extending from a front central portion of the parallepiped frame, the anti-tip members preventing excessive pivoting of the trash bin during loading/hauling.

7. The trash receptacle loading frame according to claim 1, further comprising a pair of standoff members extending from the roll-off members, the standoff members supporting the raised front portion of the parallelepiped frame.

8. The trash receptacle loading frame according to claim 1, further comprising a hook bar extending laterally between and attached to the opposing portions of the A-frame member, the hook bar facilitating engagement of a truck hook with the A-framed hook engaging member.
